(19) United States
(12) Patent Application Publication
(10) Pub. No.: US 2025/0328899 A1
(43) Pub. Date: Oct. 23, 2025

(54) SYSTEM AND METHODS OF SECURE BUSINESS-TO-BUSINESS TRANSACTIONS

(71) Applicant: Dell Products L.P., Round Rock, TX (US)

(72) Inventors: John Hickie, Dublin (IE); Manav Ghosh, Bangalore (IN); Som Shankar Sahoo, Bangalore (IN)

(73) Assignee: Dell Products L.P., Round Rock, TX (US)

(21) Appl. No.: 18/641,792

(22) Filed: Apr. 22, 2024

(51) Int. Cl. G06Q 20/38

(52) U.S. Cl. CPC G06Q 20/389

(57) ABSTRACT

Methods and systems for generating and executing secure transactions in a business-to-business (B2B) environment are disclosed. Secure B2B transactions are implemented through a private blockchain network. An enterprise-wide private blockchain network is implemented between the concerning parties of a B2B transaction for the duration of a purchase cycle. The private network may include a number of sub-systems and transactions between parties, including the sub-systems, may be executed via one or more channels using smart contracts. Transactions are be endorsed by relevant parties before details of the transaction are added to a distributed ledger.

### BACKGROUND

Business-to-business (B2B) transactions in the e-commerce world include the exchange of products, services or information between businesses, such as a wholesaler and an online retailer. In B2B business models, each organization may have certain negotiation powers and seek benefits on large orders. Usually, B2B transactions involve large orders and higher dollar amounts. Many parties from multiple departments in an organization are involved in the buying decisions.

Typically, B2B transactions between sellers and customers occur through application programming interface (API) or electronic data interchange (EDI) transactions or, in some cases, a combination of both. API- and EDI-based transactions are limited as one single failure in a method call in an API can result in significant losses for the organization. Further, API and EDI based transactions are prone to network glitches, traffic hogs and message loss.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect, a computer-implemented method may include providing a first channel in a private network between a first system and a second system and receiving a first function over the first channel. A first endorsement of the first function may be received from each of the first system and the second system. A first distributed ledger may be generated including the first function and the first endorsement. The first distributed ledger may be available only to the first system and the second system. A second channel in the private network may be provided between the first system and at least one subsystem. A second function related to the request may be deployed over the second channel. A second endorsement of the second function may be received from the first system and the at least one subsystem. A second distributed ledger may be generated including the second function and the second endorsement. The second distributed ledger may be available only to the first system and the at least one subsystem.

The method may include, alone or in combination, one or more of the following features. A third function related to the second function may be deployed over the first channel. A third endorsement of the third function may be received from the first system and the second system and the first distributed ledger may be appended with the third function and the third endorsement. The first distributed ledger may be stored at the first system and the second system. The second distributed ledger may be stored at the first system and the at least one subsystem. The first function and the second function each may include smart contracts. The private network may include a blockchain network. The first system and the at least one subsystem may comprise a business-to-business ecosystem. The first system may comprise a customer interface. A third channel may be provided between a third system and the first system. The third channel may be isolated from the first channel. The first function may be encrypted.

According to another aspect, a system may comprise a memory and at least one processor that is operatively coupled to the memory. The at least one processor being configured to perform the operations of providing a first channel in a private network between a first system and a second system and receiving a first function over the first channel. A first endorsement of the first function may be received from each of the first system and the second system. A first distributed ledger may be generated including the first function and the first endorsement. The first distributed ledger may be available only to the first system and the second system. A second channel in the private network may be provided between the first system and at least one subsystem. A second function related to the request may be deployed over the second channel. A second endorsement of the second function may be received from the first system and the at least one subsystem. A second distributed ledger may be generated including the second function and the second endorsement. The second distributed ledger may be available only to the first system and the at least one subsystem.

The system may include, alone or in combination, one or more of the following features. A third function related to the second function may be deployed over the first channel. A third endorsement of the third function may be received from the first system and the second system and the first distributed ledger may be appended with the third function and the third endorsement. The first distributed ledger may be stored at the first system and the second system. The second distributed ledger may be stored at the first system and the at least one subsystem. The first function and the second function each may include smart contracts. The private network may include a blockchain network. The first system and the at least one subsystem may comprise a business-to-business ecosystem. The first system may comprise a customer interface. A third channel may be provided between a third system and the first system. The third channel may be isolated from the first channel. The first function may be encrypted.

According to another aspect, a non-transitory computer-readable medium storing one or more processor-executable instructions, which when executed by at least one processor, cause the at least one processor to perform the operations of providing a first channel in a private network between a first system and a second system and receiving a first function over the first channel. A first endorsement of the first function may be received from each of the first system and the second system. A first distributed ledger may be generated including the first function and the first endorsement. The first distributed ledger may be available only to the first system and the second system. A second channel in the private network may be provided between the first system and at least one subsystem. A second function related to the request may be deployed over the second channel. A second endorsement of the second function may be received from the first system and the at least one subsystem. A second distributed ledger may be generated including the second function and the second endorsement. The second distributed ledger may be available only to the first system and the at least one subsystem.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a flow diagram of a business-to-business (B2B) transaction, according to aspects of the present disclosure;

FIG. 2 is a diagram of an example of a B2B system, according to aspects of the present disclosure;

FIG. 3 is a partial code segment defining a plurality of transactions, according to aspects of the present disclosure;

FIG. 4A is a flow diagram of an endorsement procedure, according to aspects of the present disclosure;

FIG. 4B is a partial code segment defining an endorsement policy on a first channel, according to aspects of the present disclosure;

FIG. 4C is a partial code segment defining an endorsement policy on a second channel, according to aspects of the present disclosure;

FIG. 5 is a diagram of another example of a B2B system, according to aspects of the present disclosure;

FIG. 6A is a diagram of a first block of a blockchain structure, according to aspects of the present disclosure;

FIG. 6B is a diagram of a series of blockchain transactions, according to aspects of the present disclosure;

FIG. 7A is a partial code segment implementing a transaction on a first channel, according to aspects of the present disclosure;

FIG. 7B is a partial code segment of a payload for the transaction of FIG. 6D, according to aspects of the present disclosure;

FIG. 7C is a partial code segment implementing a transaction on a second channel, according to aspects of the present disclosure;

FIG. 7D is a partial code segment of a payload for the transaction of FIG. 7C, according to aspects of the present disclosure;

FIG. 7E is a partial code segment implementing a transaction on a second channel, according to aspects of the present disclosure;

FIG. 7F is a partial code segment of a payload for the transaction of FIG. 7E, according to aspects of the present disclosure;

FIG. 8 is a flow diagram of an example of executing a secure B2B transaction, according to aspects of the disclosure; and

FIG. 9 is a diagram of an example of a computing device, according to aspects of the disclosure.

### DETAILED DESCRIPTION

Aspects of the present disclosure relate to methods and systems for generating and executing secure transactions in a business-to-business (B2B) environment or ecosystem. Secure B2B transactions may be implemented through one or more private blockchain networks. An enterprise-wide private blockchain network may be implemented between the concerning parties of a B2B transaction for the duration of a purchase cycle. A private network in blockchain may refer to a network in which the participants are limited and permissioned. For example, only specific entities or individuals are allowed to join and interact with the network. The private network may also be referred to herein as a permissioned blockchain network. A distributed ledger-based private blockchain may ensure zero transaction losses, a secured network of nodes across the enterprise and data integrity between the users of the blockchain system.

According to one aspect, the private network may include a number of sub-systems and transactions between parties, including the sub-systems may be executed via one or more channels using smart contracts. As used herein, smart contracts may include computerized transaction programs or protocols that automatically execute the terms of a contract.

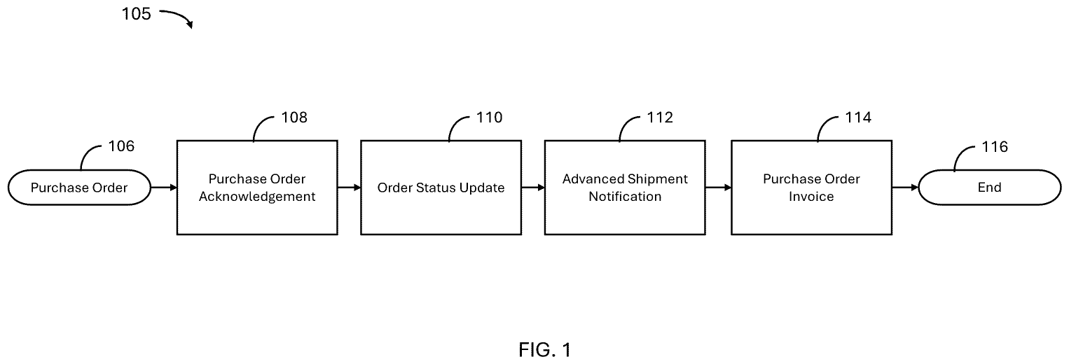

FIG. 1 is a flow diagram of a B2B transaction workflow 105, according to aspects of the present disclosure. For example, a consumer/vendor order workflow, such as workflow 105, may be implemented with the methods and systems disclosed herein. The workflow 105 may include a number of transactions between a buyer, a vendor and one or more subsystems of the vendor. In a traditional B2B architecture, these transactions may have included documents, payloads, messages or notifications and are communicated through one or more electronic data interchanges (EDI) or application programming interfaces (APIs). According to aspects of the present disclosure, each of the identified transactions in the workflow 105 may be smart contracts executed between relevant parties, the results of which may be immutably captured in a distributed ledger.

According to one aspect, a purchase order (PO), as shown in block 106, may include details on the products, pricing, addresses and billing. The PO may be sent from the customer to the vendor, supplier, or other provider of goods and services. As shown in block 108, Purchase Order Acknowledgement (POA) may include confirmation to the customer that the PO was received. The POA may be sent from the vendor to the customer. As shown in block 110, Order Status Updates (OS) may provide updated status information per order, including without limitation, “Out for Delivery”, “Shipped”, or the like. The OS may be sent from the vendor to the customer.

As shown in block 112, an Advanced Shipping Notification (ASN) may include a notification to indicate that items ordered have been shipped. The ASN may be sent from the vendor to the customer. As shown in block 114, a PO Invoice may include a final invoice sent from the vendor to the customer. As shown in block 116, the purchase cycle may be complete and the workflow 105 ends.

As previously stated, traditional B2B transactions may be executed using EDI services, API services, or both. The use of these services, however, may present concerns. For example, in a traditional B2B ecosystem there is no single source of truth. Each stakeholder may hold a copy of each transaction. There may be disparate sources of various information about business process transactions. As such, it is possible that each stakeholders' individual system maintains its own transaction records, which can result in discrepancies and duplications that cause confusion and disagreements. Consequently, extensive time-consuming efforts may be required to reconcile these discrepancies.

According to one aspect, the use of private networks and distributed ledger technology may record the transaction data in a decentralized and immutable manner, ensuring that the data remains accurate and tamper-proof. The immutability of a distributed ledger detailing transaction data may provide several practical benefits. For example, immutability may ensure that the transaction data remains secure and tamper-proof, thereby reducing the risk of fraud or data breaches. Further, using distributed ledger technology provides a practical mechanism for both parties to access and verify the transaction data, increasing transparency and trust between the two parties. Additionally, with immutability, time-consuming reconciliations or dispute resolutions may be avoided, as both parties can rely on the accuracy and integrity of the transaction records.

Further, traditional B2B ecosystems are centralized. For example, when customer-facing components, such as the PO API or EDI, go down POs may not be initiated or executed. Further, a centralized system may be vulnerable to a single point of failure, which can result in security breaches and the loss or compromise of sensitive data. Distributed ledger technology, as described herein, provides a more practical and resilient technology. For example, the methods and systems described herein may use a decentralized architecture that distributes data across a network of nodes, which makes the system more resilient to failures or attacks. Using a decentralized architecture that distributes data across multiple nodes means that there is no single point of failure. If one node fails or is compromised, the network can continue to operate, ensuring that data remains available and transactions can be processed.

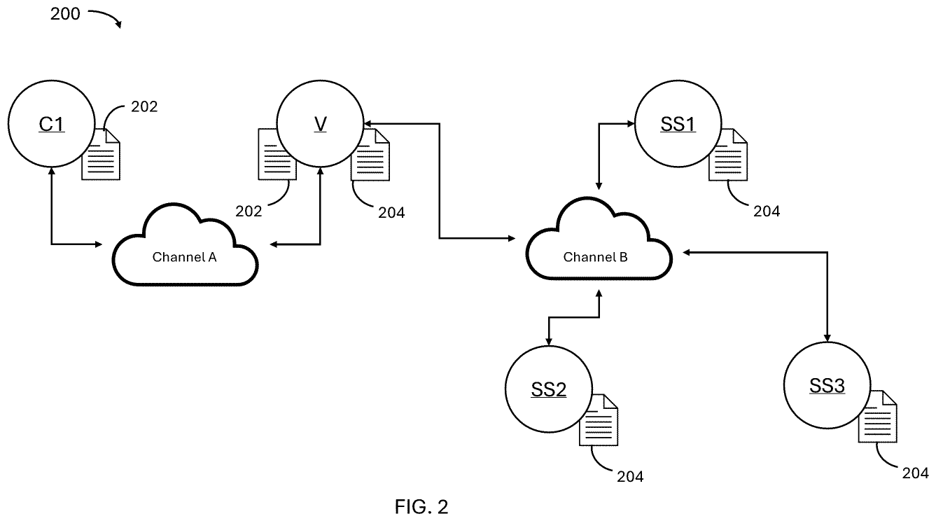

FIG. 2 is a diagram of an example of a B2B system 200, according to aspects of the present disclosure. For explanation purposes only, the B2B system 200 may include a customer/vendor system in which a customer C1 interacts with a vendor V and one or more subsystems SS1, SS2, SS3 of the vendor V. According to one aspect, and for illustration purposes only, the subsystems may include, for example, an order management subsystem (SS1), a purchase order processing subsystem (SS2), and a billing and invoicing subsystem (SS3). The system 200 may further include one or more private networks, or channels, between the various entities. For example, Channel A may form or define a first private network between the customer C1 and the vendor C while Channel B may form or define a second private network between the vendor V and the subsystems SS1, SS2, SS3.

According to one or more aspects, as used herein, channels may refer to and/or include mechanisms allowing for the creation of private and secure communication pathways between specific participants within a blockchain network. Channels, such as Channel A and Channel B, may enable direct and confidential transactions or interactions between these participants without broadcasting the information to the entire network.

According to one aspect, channels may provide a way to limit visibility and access to certain transactions, allowing participants to transact privately and selectively share information. In the example B2B system 200 the customer may be placing an order with the vendor V, however there are certain transactions and information to which the customer C1 need not or should not be privy. Accordingly, while the parties to Channel A, the customer C1 and the vendor V, may execute transaction and share information with each other, the customer C1 is isolated from the transactions and information executed between the vendor V and the subsystems SS1, SS2, SS3 over Channel B.

According to one aspect, the B2B system may utilize smart contracts to control the transactional workflow between the parties. The smart contracts may run on the private networks themselves and execute transactions based on predefined methods (contracts) and subject to predefined permissions. The smart contracts may be deployed to the private network and made accessible to the relevant participants within the channels where the contract should be executed. Accordingly, participants within a specific channel can interact with the deployed smart contract.

For instance, in the scenario where the customer C1 and vendor V want to execute a specific business process within Channel A, a Purchase Order may be submitted. Customer C1's system may call a purchase order smart contract, which may be deployed on the channel. The initiation of the smart contract may generate a first ledger 202 to capture and record the transaction. The result of the execution of the smart contract and any changes to the state of the first ledger 202 may be recorded as an immutable transaction on the first ledger 202 specific to Channel A. Only the systems involved in Channel A can access and verify the transaction details.

Similarly, on Channel B, the vendor V, upon receiving the purchase order smart contract, may initiate its own smart contracts and generate a second ledger 204 to capture the transactions processed over and specific to Channel B between the vendor V and the subsystems SS1, SS2, SS3. Only the vendor V is authorized to store, maintain, and update both the first ledger 202 and the second ledger 204.

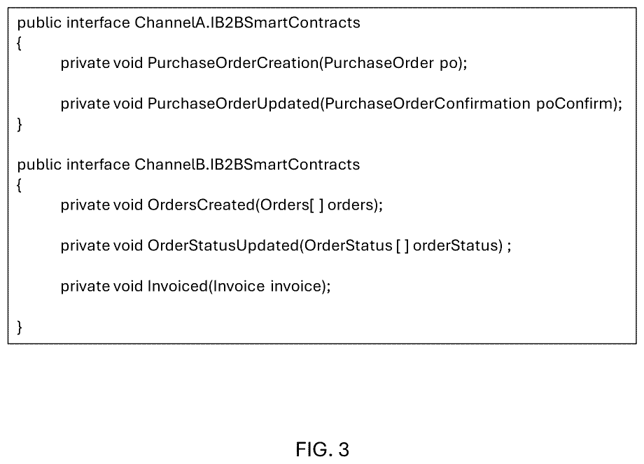

According to one aspect, and continuing the illustrative example of a purchase order workflow, the system 200 may define and/or include smart contracts such as “PurchaseOrderCreation”, “PurchaseOrderUpdated”, “OrdersCreated”, “OrderStatusUpdated”, and “Invoiced”. FIG. 3 is a partial code segment reflecting the definition of the smart contracts. For example, the system may define smart contracts “PurchaseOrderCreation”, and “PurchaseOrderUpdated” as available smart contracts over Channel A. In the context of the system 200 of FIG. 2, these reflect the smart contracts and transactions that may occur between the customer C1 and the vendor V. Similarly, smart contracts “OrdersCreated”, “OrderStatusUpdated”, and “Invoiced” may be available over Channel B, reflecting the smart contracts and transactions that may occur between the vendor V and one or more of the subsystems SS1, SS2, SS3.

According to one aspect, each transaction may be validated or approved prior to recording the transaction to the distributed ledgers using an endorsement policy. As used herein, endorsements may refer to the validation or approval of a transaction or a block of transactions by the appropriate participants or systems within a private network. Endorsements may play a role in achieving consensus and ensuring the integrity and security of the ledgers.

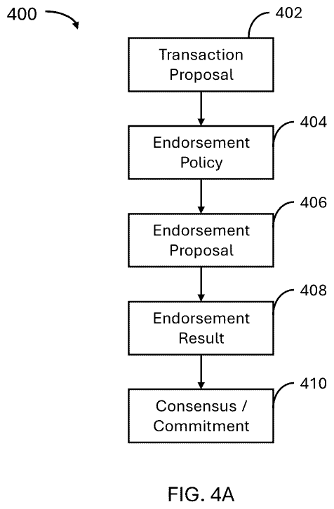

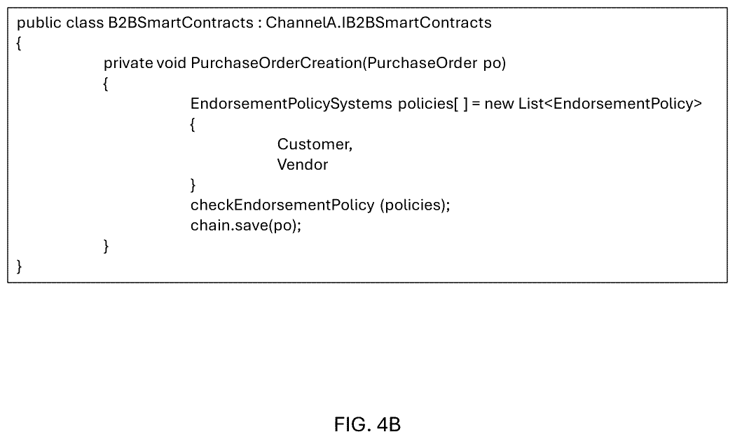

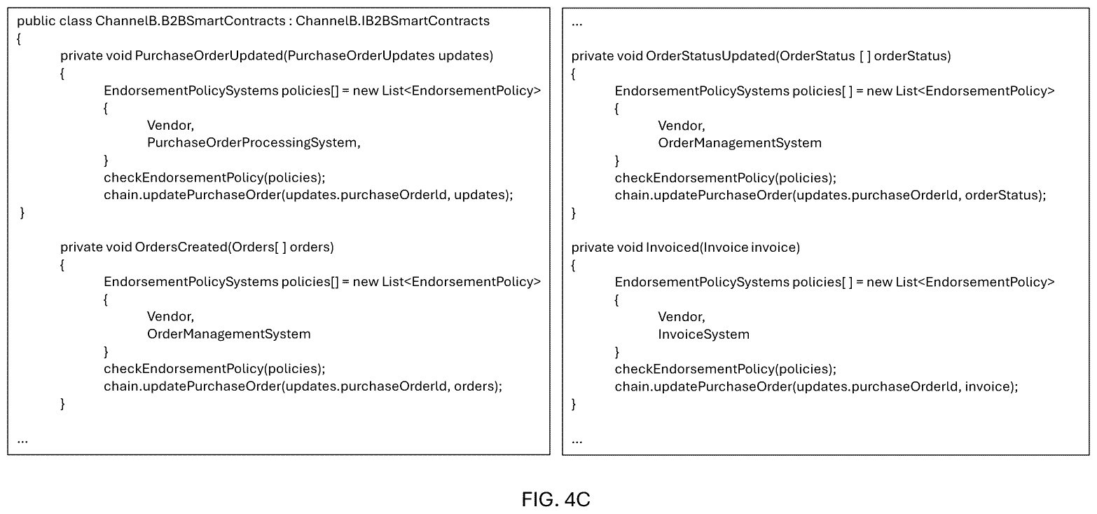

FIG. 4A is a flow diagram of an endorsement procedure 400. According to one aspect, a system (e.g., customer, vendor and/or subsystem) may initiate a transaction proposal, shown in block 402, by executing a smart contract on a particular channel. Each smart contract may be associated with an endorsement policy, shown in block 404, which specifies the criteria for valid endorsements. The policy may define the required number of endorsements, the specific identities or roles of the endorsers, or other conditions. The transaction may be sent as an endorsement proposal, shown in block 406, to designated endorsers who may be responsible for verifying the validity and correctness of the transaction. Each endorser may individually sign the endorsement proposal if they agree with the results, shown in block 408. The endorsements may serve as cryptographic proofs of the endorsement process. After a consensus endorsement, shown in block 410, the transactions may be committed to the ledger, becoming an immutable part of the distributed ledger.

According to one aspect, endorsements may be used to establish the validity of a transaction before it can be added to the ledger. In particular, for example, both parties on Channel A (FIG. 2), which is responsible for transactions between the customer C1 and the B2B system of the vendor V, may need to endorse the transactions executed via a smart contract. The relevant parties on Channel B (e.g., the vendor V and the subsystems) may need to endorse the transactions executed on Channel B via a smart contract.

FIG. 4B is a partial code segment of an exemplary implementation of an endorsement policy as its own smart contract. For example, for the transaction “PurchaseOrderCreation”, both a customer and the vendor may be required to endorse the transaction before it is committed to the ledger. FIG. 4C is a partial code segment of an exemplary implementation of endorsement policies for Channel B between the Vendor, Order Management subsystem, Purchase Order Processing subsystem, and Invoicing subsystem.

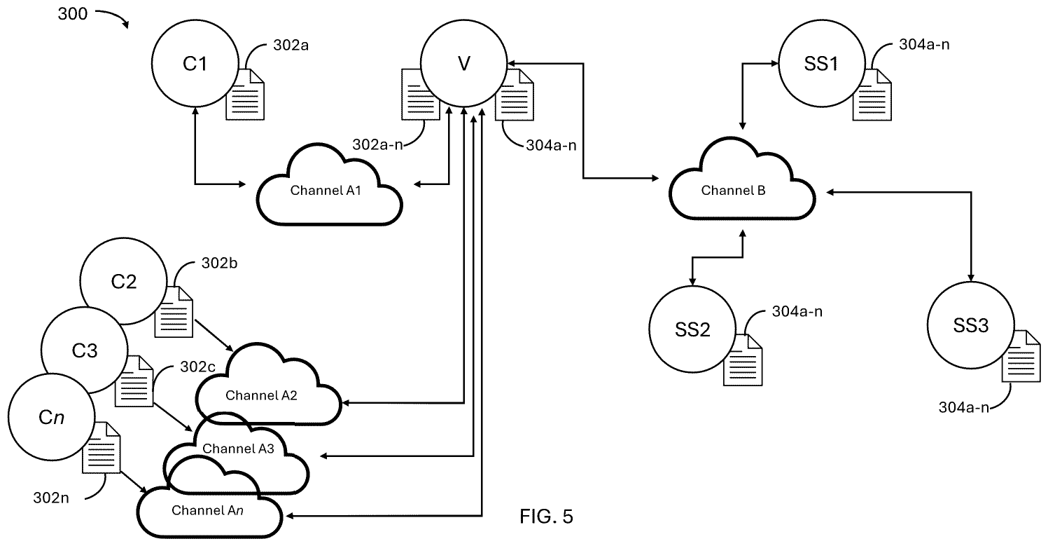

FIG. 5 is a diagram of another example of a B2B system 300, according to aspects of the present disclosure. As described herein, the B2B system 300 may provide a secure transaction environment between a vendor V and one or more customers, such as C1, C1, C3 . . . . Cn. Each customer may interact and execute transactions with the vendor V through private blockchain networks defined individually for each customer. For example, C1 may execute transactions, as described herein, over Channel A1 using smart contracts and a ledger 302a that only C1 and vendor V may access. Similarly, customers C2, C3, Cn, may interact with the vendor V system over separate and isolated channels, such as Channels A2, A3, An, respectively. Each customer and each channel may include their own smart contracts and ledgers, 302b, 302c, 302n.

The vendor V may have access to and execute transactions over each channel. Vender V may also have the authority to endorse and modify each of the ledgers (collectively, 302a-n) for the respective customers. The vendor may also interact with and execute transactions with the subsystems SS1, SS2, SS3, over Channel B where ledgers 304a-n may be generated and updated, as described herein, for each of the customers and their purchase orders. In this manner, all information supplied to the vendor V by a customer is isolated from the other customer channels across the private networks.

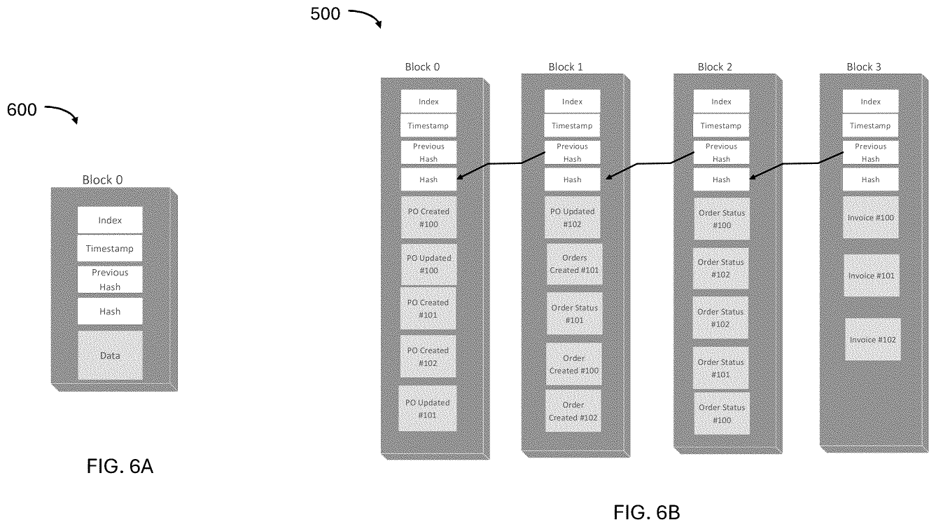

Turning now to FIG. 6A, a diagram of a first block 600 of a blockchain structure, according to aspects of the present disclosure. Each block 600 may contain a header and a body. The body of the block 600 may hold the data that needs to be stored. The header may contain, for example, an index, a timestamp, a previous hash, and a current hash. The first block 600 may be block 0 (or a genesis block). The index may be incremented per new block, as described herein. The timestamp may reflect the date and time the block was created. The previous hash may include a hash constructed from the data in the previous block (if it exists). The current hash may include a hash constructed from the data in the current block. The body of the block may include a payload, for example, a JavaScript Object Notation (JSON) of the transactions themselves.

FIG. 6B is a diagram of a series of blockchain transactions 500, according to aspects of the present disclosure. For example, a genesis block (block 0) may include three purchase orders (PO #100, PO #101, PO #103). Each of these purchase orders may include, for example, several transactions which correspond to one or more of the smart contracts discussed herein: “PurchaseOrderCreation” “PurchaseOrderUpdated,” “OrdersCreated,” “OrderStatusUpdated,” and “Invoiced”. In the exemplary implementation of FIG. 6B, there may be five transactions per block; however, one skilled in the art will recognize that the number of transactions per block may be configured to include a different number. For example, depending on the infrastructure of the system each block could include several thousand transactions per block. As such, for any particular purchase order the transactions associated with that order may be potentially spread across multiple blocks.

According to one aspect, once the max number of transactions per block (five in the example of FIG. 6B) is reached a new block may be created. The newly created block may be appended to the existing chain of blocks, forming a linear sequence, for example, Block 0-Block 3. The newly created block may become part of the permanent and immutable ledger of the blockchain network. The updated blockchain may be replicated across all the participating systems in the network. By following this process, transaction data may be securely and immutably added to the blockchain, ensuring transparency, integrity, and decentralized consensus among participants in the network.

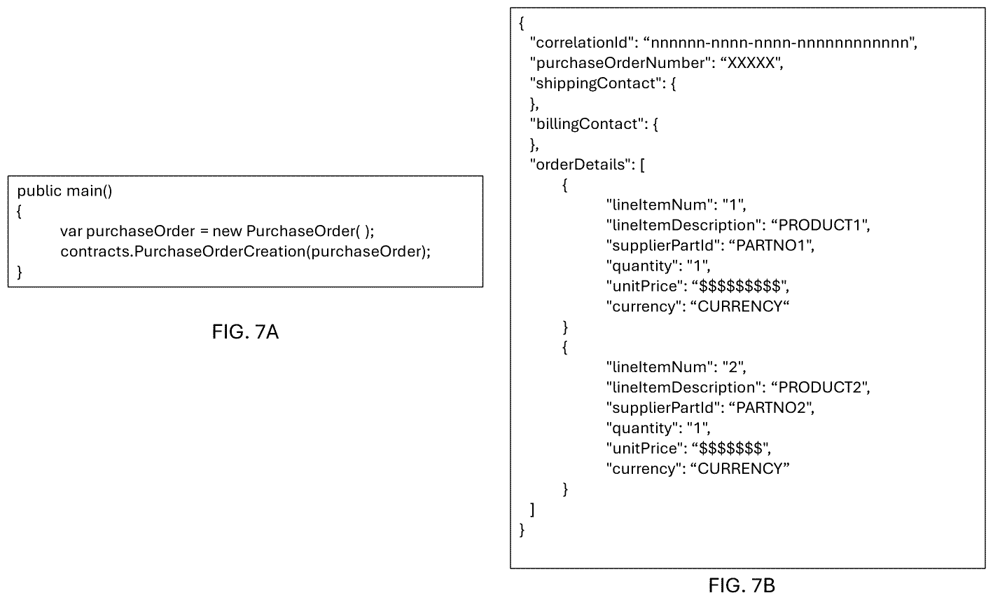

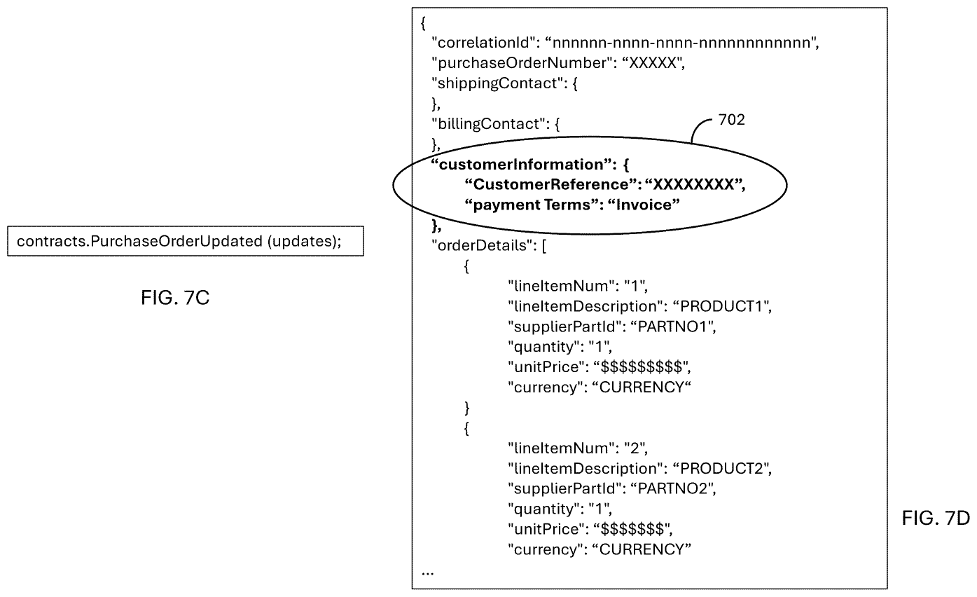

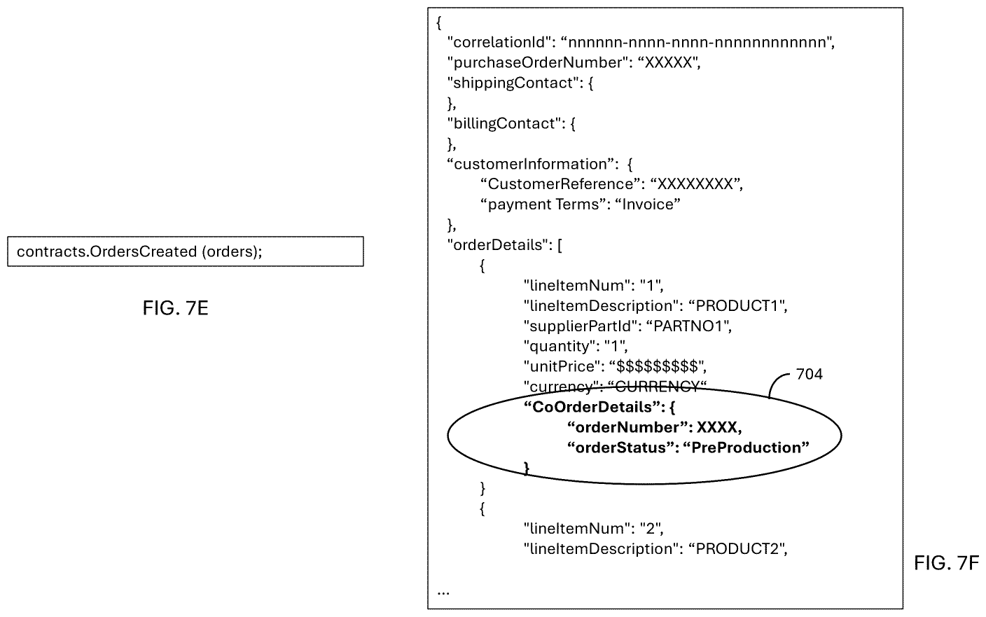

Referring now to FIGS. 7A-7F, a partial workflow of an implementation of a secure B2B transaction environment, like that shown in FIG. 2, may include execution of one or more smart contracts across private networks between a customer and a vendor, and between the vendor and one or more subsystems. FIG. 7A is a partial code segment implementing a transaction on a first channel, according to aspects of the present disclosure. A customer (e.g., C1 of FIG. 2) may call a “PurchaseOrderCreation” smart contract on a first channel (e.g., Channel A of FIG. 2). FIG. 7B is a partial code segment of a payload, such as a JSON, for the transaction, according to aspects of the present disclosure. According to one aspect, the JSON may be or include the blockchain ledger for the transaction cycle. The payload may include order details such as an item number (“lineItemNum”), an item description (“lineItemDescription”), a supplier part number (“supplierPartId”), a quantity, and a currency indicator. The payload may include additional items or products included in the order, (i.e., PRODUCT2″) and its associated data.

Once the purchase order is received by the vendor system (e.g., vendor V of FIG. 2), an endorsement policy is checked and if the parties involved provide consensus, the transaction may be saved to the blockchain ledger (i.e., appended to the payload). According to one aspect, the endorsement policy may be similar to that shown in FIG. 4B. When the customer and the vendor endorse the purchase order creation, the ledger is automatically made available as a distributed ledger to the parties on Channel A: C1 and vendor V.

The Purchase Order Processing Subsystem may validate the purchase order and append additional information specific to the customer before calling a PurchaseOrderUpdated smart contract on Channel B. FIG. 7C depicts a partial code segment invoking the PurchaseOrderUpdated smart contract. FIG. 7D shows an updated payload in which customer information, shown as 702, has been entered into the record. The endorsement policy for “PurchaseOrderUpdates” (FIG. 4C) may be checked and if the parties involved (i.e., the vendor and Purchase Order Processing Subsystem) provide consensus, then the data is saved to the private blockchain network as an updated distributed ledger available to the parties on Channel B.

The Order Management Subsystem may validate the purchase order and create orders that may then be used to track the logistics of the order. FIG. 7E is a partial code segment invoking the OrdersCreated smart contract. FIG. 7F shows an updated payload in which order details (“CoOrderDetails”), shown as 704, have been appended to the first listed item. The additional order details may include, for example, an order number and an order status, reflecting internal order logistics for the order of PRODUCT1. Other order details for the additional products or items in the order, such as for PRODUCT2, may also be added concurrently. Again, an endorsement policy for “OrdersCreated” (FIG. 4C) may be checked and if the parties involved (i.e., the vendor and Order Management Subsystem) provide consensus, then the data is saved to the private blockchain network as an updated distributed ledger available to the parties on Channel B.

The workflow may continue in this manner across Channel B and the various subsystems to fulfill the order, appending information to the payloads, seeking and receiving endorsements from the appropriate parties, and saving the updated payload as a distributed ledger to the private blockchain network (e.g., Channel B). When updates that are made to the Channel B distributed ledger include information that may need to be shared with the customer, shipping or tracking information, order status or the like, the vendor may initiate the appropriate smart contract over Channel A. That transaction may be executed, endorsed and immutably recorded in the Channel A distributed ledger, according to the systems and methods described herein.

The illustrative partial workflow described above is exemplary and may be implemented and/or include additional transactions and additional and different smart contracts. One skilled in the art will recognize that the partial workflow described above is exemplary and the scope of the present disclosure is not limited to only those subsystems, transactions, smart contracts, and workflow steps. Nor are the methods and systems described herein limited to a customer/vendor purchase order environment and other practical B2B applications may be implemented using the concepts and techniques described herein.

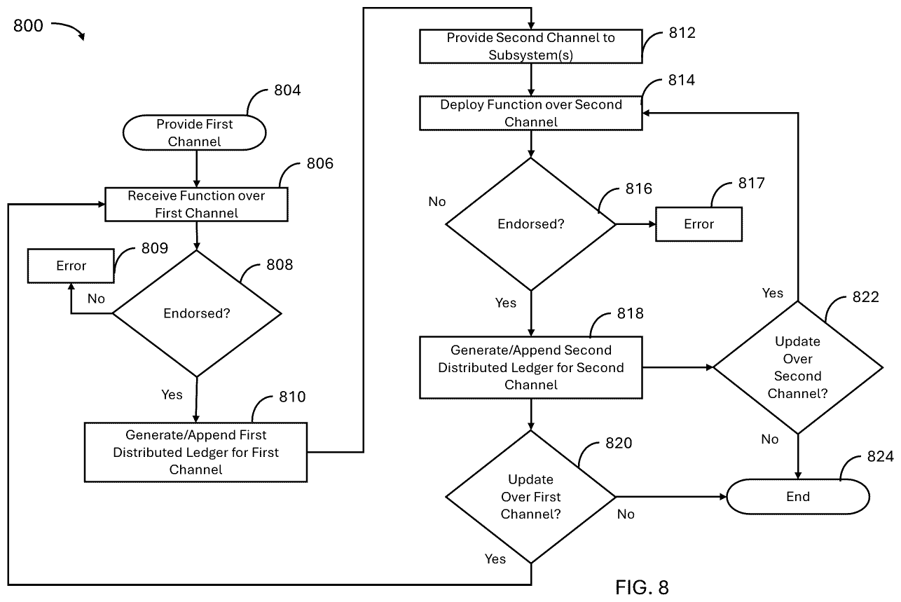

FIG. 8 is a flow diagram of an example method 800 of executing a secure B2B transaction, according to aspects of the disclosure. As described herein, and shown in block 804, a first channel may be provided. The first channel may include a private and secure communication pathway between participants within a blockchain network, including a customer and a vendor. As shown in block 806, the vendor may receive over the first channel a function in the form of a smart contract defining and creating, for example, a purchase order for a number of products or services. As shown in block 808, an endorsement policy may be checked. If the parties (i.e., the customer and the vendor) provide consensus, as shown in block 810, a distributed ledger may be generated or appended with the details of the order. The distributed ledger may be deployed and saved to the parties on the first channel. If an endorsement is not obtained, the information is not saved to the distributed ledger and an error may be recorded for tracking purposes, as shown in block 809.

As shown in block 812, a second channel may be provided between the vendor and one or more subsystems. As shown in block 814, a function may be deployed over the second channel, by either the vendor or a subsystem. The function may be a smart contract configured to add additional information to the record related to the customer transaction, such as an update to the purchase order. The smart contract may add additional information to a payload. As shown in block 816, an endorsement policy may be checked. If the parties (i.e., the subsystem and the vendor) provide consensus, as shown in block 818, a second distributed ledger may be generated or appended with the additional details of the order. If an endorsement is not obtained, the information is not saved to the distributed ledger and an error may be recorded for tracking purposes, as shown in block 817. The second distributed ledger may be deployed and saved to the parties on the second channel. As described herein, the information appended to the second distributed ledger may not be available to any party other than those participating on the second channel.

As shown in block 820, a determination may be made to provide information from a transaction executed on the second channel to be communicated to a party on the first channel (e.g., a customer update). In such a case, the method may return to block 806 where a function may be deployed by the vendor over the first channel and executed, endorsed and saved as previously described. If a subsequent transaction is needed between any of the parties on the second channel, as determined in block 822, the method may return to block 814 where a function may be deployed, executed, endorsed and saved as previously described. As shown in block 824, if no additional functions need to be deployed, the method may end, and the product cycle workflow is complete.

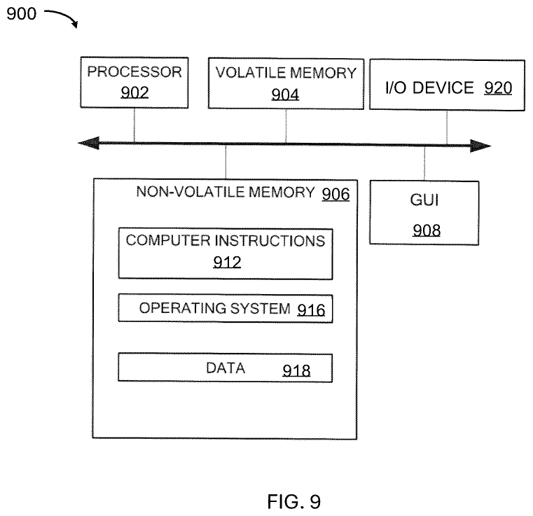

Referring to FIG. 9, in some embodiments, a computing device 900 may include processor 902, volatile memory 904 (e.g., RAM), non-volatile memory 906 (e.g., a hard disk drive, a solid-state drive such as a flash drive, a hybrid magnetic and solid-state drive, etc.), graphical user interface (GUI) 908 (e.g., a touchscreen, a display, and so forth) and input/output (I/O) device 920 (e.g., a mouse, a keyboard, etc.). Non-volatile memory 906 stores computer instructions 912, an operating system 916 and data 918 such that, for example, the computer instructions 912 are executed by the processor 902 out of volatile memory 904. Program code may be applied to data entered using an input device of GUI 908 or received from I/O device 920.

FIGS. 1-9 are provided as an example only. At least some of the steps discussed with respect to FIGS. 1-9 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used throughout the disclosure, the term “vector” refers to a sequence of numbers (and/or other elements).

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

What is claimed is:

1. A computer-implemented method comprising:
providing a first channel in a private network between a first system and a second system;
receiving a first function over the first channel;
receiving a first endorsement of the first function from each of the first system and the second system;
generating a first distributed ledger including the first function and the first endorsement, wherein the first distributed ledger is available only to the first system and the second system;
providing a second channel in the private network between the first system and at least one subsystem;
deploying a second function related to the first function over the second channel;
receiving a second endorsement of the second function from the first system and the at least one subsystem; and
generating a second distributed ledger including the second function and the second endorsement, wherein the second distributed ledger is available only to the first system and the at least one subsystem.

2. The method of claim 1 further comprising:
deploying a third function related to the second function over the first channel;
receiving a third endorsement of the third function from the first system and the second system; and
appending the first distributed ledger with the third function and the third endorsement.

3. The method of claim 1 wherein the first distributed ledger is stored at the first system and the second system.

4. The method of claim 1 wherein the second distributed ledger is stored at the first system and the at least one subsystem.

5. The method of claim 1 wherein the first function and the second function each include smart contracts.

6. The method of claim 1 wherein the private network includes a blockchain network.

7. The method of claim 1 wherein the first system and the at least one subsystem comprise a business-to-business ecosystem.

8. The method of claim 7 wherein the first system comprises a customer interface.

9. The method of claim 1 further comprising providing a third channel between a third system and the first system, wherein the third channel is isolated from the first channel.

10. The method of claim 1 further comprising encrypting the first function.

11. A system comprising:
a memory; and
at least one processor that is operatively coupled to the memory, the at least one processor being configured to perform the operations of:
providing a first channel in a private network between a first system and a second system;
receiving a first function over the first channel;
receiving a first endorsement of the first function from each of the first system and the second system;
generating a first distributed ledger including the first function and the first endorsement, wherein the first distributed ledger is available only to the first system and the second system;
providing a second channel in the private network between the first system and at least one subsystem;
deploying a second function related to the first function over the second channel;
receiving a second endorsement of the second function from the first system and the at least one subsystem; and
generating a second distributed ledger including the second function and the second endorsement, wherein the second distributed ledger is available only to the first system and the at least one subsystem.

12. The system of claim 10 wherein the at least one processor is further configured to perform the operations of:
deploying a third function related to the second function over the first channel;
receiving a third endorsement of the third function from the first system and the second system; and
appending the first distributed ledger with the third function and the third endorsement.

13. The system of claim 11 wherein the first distributed ledger is stored at the first system and the second system and the second distributed ledger is stored at the first system and the at least one subsystem.

14. The system of claim 11 wherein the first function and the second function each include smart contracts.

15. The system of claim 11 wherein the private network includes a blockchain network.

16. The system of claim 11 wherein the first system and the at least one subsystem comprise a business-to-business ecosystem.

17. The system of claim 11 wherein the first system comprises a customer interface.

18. The system of claim 11 further comprising providing a third channel between a third system and the first system, wherein the third channel is isolated from the first channel.

19. The system of claim 11 further comprising encrypting the first function.

20. A non-transitory computer-readable medium storing one or more processor-executable instructions, which when executed by at least one processor cause the at least one processor to perform the operations of:
providing a first channel in a private network between a first system and a second system;
receiving a first function over the first channel;
receiving a first endorsement of the first function from each of the first system and the second system;
generating a first distributed ledger including the first function and the first endorsement, wherein the first distributed ledger is available only to the first system and the second system;
providing a second channel in the private network between the first system and at least one subsystem;
deploying a second function related to the first function over the second channel;
receiving a second endorsement of the second function from the first system and the at least one subsystem; and
generating a second distributed ledger including the second function and the second endorsement, wherein the second distributed ledger is available only to the first system and the at least one subsystem.
